(19) United States
(12) Patent Application Publication
(10) Pub. No.: US 2018/0008024 A1
(43) Pub. Date: Jan. 11, 2018

(54) CLIP AND WEBBING SYSTEM TO JOIN MULTIPLE BAGS AND AVOID MULTIPLE CARRYING STRAPS BY UTILIZING THE STRUCTURE OF ONE BAG OR BY JOINING THEM TOGETHER

(71) Applicant: Priscilla Barton, Dublin, CA (US)

(72) Inventor: Priscilla Barton, Dublin, CA (US)

(21) Appl. No.: 15/206,334

(22) Filed: Jul. 11, 2016

(51) Int. Cl. A45C 13/00; A47D 13/02; A45F 3/04; F16B 2/22; A45C 1/02

(52) U.S. Cl. CPC A45C 13/001; F16B 2/22; A45C 1/02; A45F 3/04; A47D 13/025

(57) ABSTRACT

The present invention relates to a method of using the structure of an existing bag (or baby carrier) and attaching another bag (or baby carrier or other items) by means of an attachment point between the existing bag thus allowing another bag (or multiple bags) to be used without its strap or to be joined together as one bag. This allows multiple bags and items of various kinds to be attached to one another for any reason utilizing a peculiar clip and webbing system comprising an S-shaped clip which holds onto webbing, rests upon the webbing and accepts webbing, while also securing it, in order to support another item.

### CROSS-REFERENCE TO RELATED APPLICATIONS

62/258,428

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention relates to a method of using the structure of an existing bag (or baby carrier) and attaching another bag (or baby carrier or other items) by means of an attachment point between the existing bag thus allowing another bag (or multiple bags) to be used without its strap or by joining the bags and straps together. This allows multiple bags and items of various kinds to be attached to one another for any reason utilizing a particular clip and webbing system comprising an S-shaped clip which holds onto webbing, rests upon the webbing and accepts webbing in order to support another item.

This field has witnessed systems and methods which allow combination of bags or baby carriers to be carried or used together thus making them portable and convenient for a user. Such bags or carriers are connected by various zipping or clip systems. Some of the prior art devices are listed below. However, the present invention presents a more innovative and inventive method of using combination of bags within the structure of a single bag or carrier.

The Patent U.S. Pat. No. 5,934,527 discloses a modular backpack having four bags connected together by zippers or snaps or the like where these bags may be used in various sub-combinations and where the bags comprise a main bag with shoulder straps useable as a backpack, a middle bag connectable to the bottom of the main bag, and a lower bag connectable to the bottom of the middle bag or directly to the bottom of the main bag. Another Patent U.S. Pat. No. 6,230,771 relates a modular carry-all assembly typically comprising two containers, one of which is connected by emplacement upon the other, each suitable for independent or separate carrying. Another prior art U.S. Pat. No. 7,600,620 relates to an improved storage bag having a retaining member disposed on the surface of a main bag. The retaining member allows supplemental bag to hang on an outside wall of the main bag. An existing storage bag can have a bracket configured to extend partially along an inside portion of a side wall of the briefcase. The bracket has a hook-portion to extend out of the top of the briefcase and partially along the outside portion of the side wall of the briefcase and a retaining member. Further, the Patent U.S. Pat. No. 8,814,016 relates to an improved backpack and waist bag carrying systems in which a waist bag rotates through a lower compartment of a backpack to allow the bearer of the backpack to access the contents of the receiver of the waist bag by rotating the waist bag to the front of the bearer's torso. However, the above disclosed inventions do not present the same structural innovations as is disclosed in the present invention. The present invention discloses an S-shaped clip which may be used in a webbing arrangement in different embodiments that is not disclosed in the previous systems.

Other traditional bags include an expandable bag system comprising a main bag and a plurality of accessory bags of various sizes which are attachable to the exterior surface of the main bag. The main bag comprises at least one sleeve arrangement having a pocket attached to a surface of the main bag by spring clips attached to a back surface of the accessory bag, the spring clip being sized to slide within the pocket of the sleeve arrangement as is disclosed in Patent U.S.20100294403. However, the additional features in the present invention make it different from the identified prior arts. Further, the Patent U.S.20150201761 relates to modular baby carrier assembly that includes a vest portion, the baby carrier assembly are attached to the front apron of the vest portion and a backpack assembly attached to the back apron of the vest portion. Further, the carrier assembly uses the MOLLE modular system on the front and back of the child carrier, allowing the wearer to customize attachments and accessories to the front and back of the child carrier. The MOLLE system includes a plurality of rows of looped structures spanning a width of the vest portion utilizing a removable and washable child carrier lining attached with hook and loop fasteners. The Patent U.S. Pat. No. 8,079,503B1 relates to a Modular Equipment Coupler which contains a member for removably attaching an accessory to a carrier, wherein the coupling member includes an elongate portion of material having a first end portion, an intermediate portion, and a second end portion. At least one hook is formed from a portion of the first end portion, wherein the hook formed from the first end portion allows the first end portion of the coupling member to be removably secured to an accessory webbing when the coupling member has been interwoven between aligned carrier tunnel segments and accessory tunnel segments of an accessory and carrier. The coupling member may optionally include a hook formed from a portion of the second end portion. This Patent contains a webbing strap similar to the present invention, but the process and system is entirely different. The Patent U.S. Pat. No. 7,124,921B1 is a personal carrying system for facilitating the carrying of objects by a user. There may be included a first personal carrying device configured to removably attach to the user. There may also be a second personal carrying device configured to removably attach to the user. Also, there may be a removable container configured to removably attach to the first personal carrying device and to the second personal carrying device and configured to contain an object therein. A first personal carrying device may be a backpack. A second personal carrying device may be a belt. The backpack and the belt may be configured to attach to each other. There may also be a leg belt. Also, there may be a second removable container that may be configured to removably attach to a bottom surface of the removable container and also to a bottom surface of the backpack. The first removable container may be configured to removably attach to the bottom surface of the backpack. Also, the first removable container and the second removable container may both be fanny packs. The concepts have also emerged in the form of patent U.S. Pat. No. 6,447,037B1 which discloses method and device for carrying plurality of bags defining a handle and strap for attaching them.

The above mentioned systems and methods of carrying a combination of bags or carriers do not specifically relate to the methods disclosed in the present disclosed invention. The present invention is an improvement in the sense that instead of utilizing multiple bags or carriers, it presents a method of utilizing a single bag or carrier to which other items or bags are attached. This makes the carrying more convenient and comfortable for users because they do not have several straps on the body causing discomfort. The bags can be integrated together to make carrying multiple bags easier. In another embodiment, the user may also join two shoulder bags together and their straps and carry the two bags as one bag. The users may carry more stuff in a single bag setting and may also attach child carrier along with a bag such as a backpack. Hence, the invention is commercially and personally an advantage over what already existed.

The limitation and non-effectiveness of the prior art has been overcome by the instant invention as described below.

### BRIEF SUMMARY OF THE INVENTION

The foregoing descriptions outline some pertinent features and objects of the present invention. These may be illustrative of more exhaustive and comprehensive features described later in the application. The technical terms used in this documents, are meant with the same meaning as understood by a typical expert of the field which is related to the invention

The present invention relates to a method of using the structure of an existing bag (or baby carrier) and attaching another bag (or baby carrier or other items) by means of an attachment point between the existing bag thus allowing another bag (or multiple bags) to be used without its strap. The bags connect through an S-shaped attachment clip which holds onto the webbing it rests upon and it supports another bag or item, in various embodiments, also equipped with webbing.

In one embodiment of the invention, the middle portion of the S-shaped clip is hooked onto the webbing and on the right side the clip has webbing hooked onto it where the clip can hold onto perpendicular pieces of webbing and also the clip can be attached using the slit on the back.

In another embodiment of the clip, the clip is provided with an additional secure attachment point attached perpendicular to the previous embodiment and this extra attachment is used to attach another item with webbing strips slid into this clip. The invention discloses numerous embodiments of the using this clip and webbing system to attach multiple bags or carriers. In a preferred embodiment, the S clip has side hooks (4 in total) that allow the user to permanently secure the webbing under the hooks of the S clip so that it does not slide out on either side. This is a more permanent means to connect two bags together to function as one bag.

It is an objective of the present disclosed invention to provide the best system with technological advance over and above the traditional systems. The present invention uses an S-shaped clip which can be attached to multiple webbing systems in a perpendicular or lateral fashion and attach one or more items to the present existing bag or carrier. This provides a more secure, convenient, stable and easy method of carrying bulk of luggage or stock. The invention is also utilized in another embodiment in which the clips connect a diaper bag with a purse which is detachable and can be carried by mother independently. The clips have utility in various forms which include combining two purses, backpack with a baby carrier or combining multiple bags. This also preserves the aesthetic sense of carrying multiple items.

These and other features, objects and advantages of the present invention will be readily visible to the persons ordinarily skilled in the art related to this field comprehending in entirety the above characteristics, following descriptions and claims of the present invention.

### BRIEF DESCRIPTION OF THE DRAWINGS

FIG. 1 shows the structure and designs of basic S-shaped clip used in the present system.

FIG. 2 shows a close-up and side profile view of the s-shaped clips.

FIG. 3 shows the back profile view one embodiment of the clip to secure it laterally

FIG. 4 shows the back profile view of one embodiment of the clip to secure it vertically.

FIG. 5 shows a preferred embodiment of the clip, having a set of hooks on the front of the clip and one set on the back which are also slightly bent towards the webbing to allow the webbing to be permanently secured in the clip so as not to move or slip out.

FIG. 6 shows the S clip secured to baby carrier straps.

FIGS. 7-8 show the front and rear view of a person wearing a baby carrier and attaching a backpack to the back of the straps using the clips to attach the backpack to the baby carrier and using only the structure of the baby carrier to carry the baby and the backpack. The straps of the backpack are folded out of the way. FIG. 8A shows the clips rotated horizontally, one embodiment where the attached item could be attached by sliding horizontally versus vertically.

FIGS. 9-10 show the front and rear perspective view a person wearing a backpack and attaching the baby carrier to the backpack via the S clips, thus utilizing the structure of the backpack to carry the baby. The baby carrier straps in this embodiment are folded away.

FIG. 11 shows a person wearing a backpack and attaching a smaller backpack to the front of their body, utilizing the structure of the large backpack to carry the weight of the smaller one. FIG. 12 shows a person wearing a backpack with the smaller backpack attached to it, allowing two bags to be carried as one using the structure of the larger bag. FIG. 13-14 show a person wearing a backpack and attaching a smaller bag such as a purse or a duffel to the backpack allowing them to carry both bags but using only the structure of the backpack. This could also be done if the person was wearing a baby carrier.

FIG. 15 shows a person wearing two bags and clipping them together using the S clip on the side of the bags, allowing them to join the two bags as if they are one bag and to carry them on the body as one bag. FIG. 16 shows another embodiment of this concept where the two bags are separately sling bags (i.e. one strap bags) that combine to form a backpack.

FIGS. 17-19 shows two bags such as a purse or shoulder bag that are attached together using the S clip, allowing the two bags to be joined together and carried as one bag as the straps are joined together.

### DETAILED DESCRIPTION OF THE INVENTION

In the present disclosure, numerous specific details are provided, such as examples and method, to provide a thorough understanding of embodiments of the invention. Persons of ordinary skill in the art will recognize, however, that the invention can be practiced without one or more of the specific details. In other instances, well-known details are not shown.

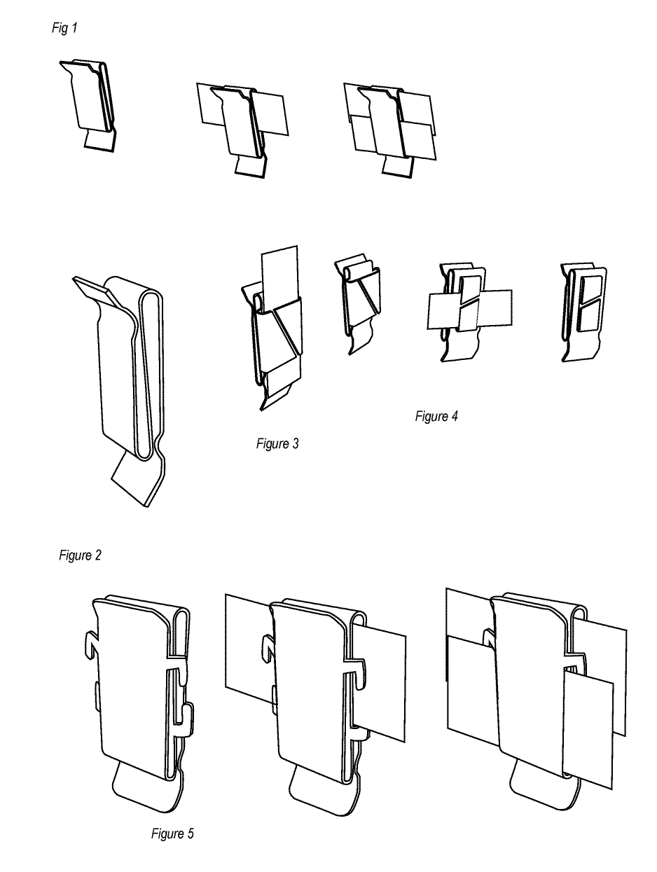

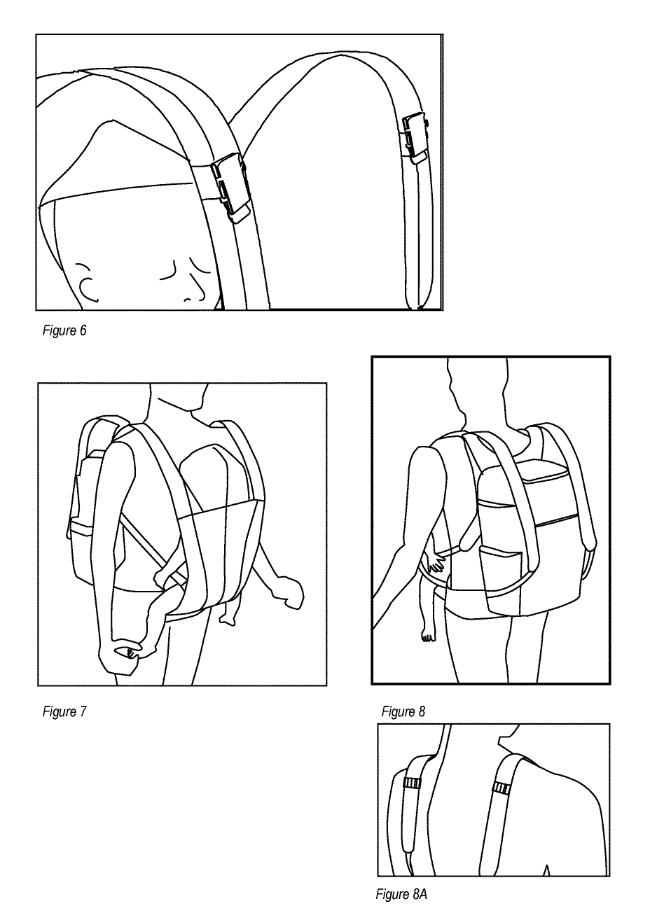

The FIG. 1 depicts the basic version of an S-shaped clip. In the diagram, it shows the clips where the middle portion of the clip is hooked onto webbing and on the right side the clip has webbing hooked onto it, providing support for another member (bag, baby carrier or any other item) to be attached onto it. The clip can hold onto perpendicular pieces of webbing and can be secured vertically or horizontally. In FIGS. 3-5, the clip is equipped with extra hooks that allow the hooks to secure to either horizontal or vertical webbing and be placed stationery for more secure and more permanent joining. FIG. 5 is the preferred embodiment of the clip, allowing the user to use it as a basic clip such as in FIG. 1 or to utilize the side hooks to futher secure the webbing under those hooks to have a more secure and permanent clip. This would be in an instance where the user plans to carry the two bags as one for an extended amount of time. The FIG. 2 shows a side-profile view of the s-shaped clip. Here you can see it also has ridges to keep the webbing in the clip with more security. Another embodiment of this clip in FIG. 3-4 is not to have the slits on the back of the clip, thus requiring the clip to be installed before sewing the webbing on entirely.

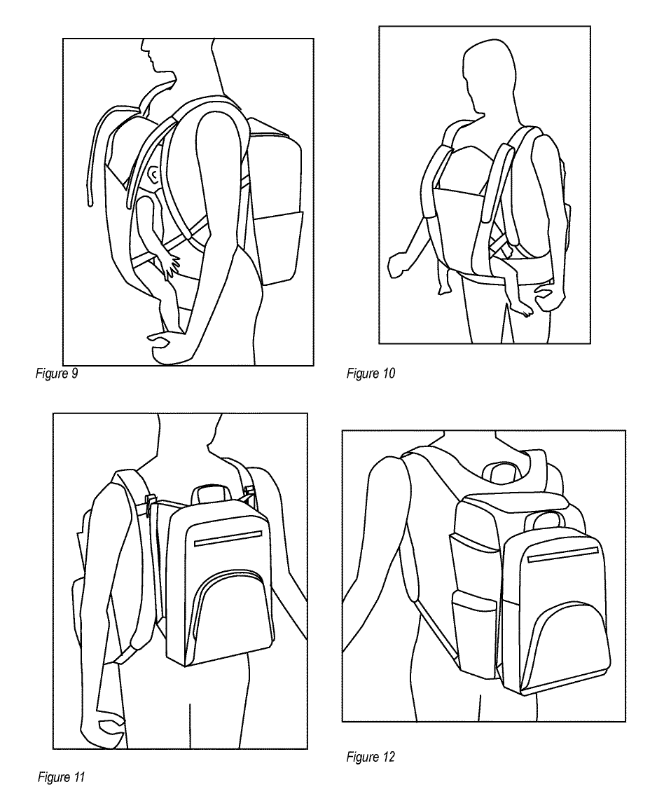

The FIGS. 6-10 shows shows the S clip attached to webbing on the straps of a bag or baby carrier. This allows another bag with webbing sewn to it to connect to the structure of this bag and eliminating the need for the user to wear two sets of straps that would oppose one another, be uncomfortable, and which may potentially lead to error with removing the baby safely from the carrier.

The FIG. 9 shows the front-view of a person wearing a backpack and a baby-carrier attached via clips. The baby carrier is not using its own straps on the shoulders, but utilizing the straps already in use on the backpack. Here, the backpack is the main bag and the baby carrier attaches to the backpack straps via the S-shaped clips or some other method of attachment using hardware. The backpack and baby carrier in these scenarios, since they still have their own respective straps, can be worn in isolation or together, making it very versatile. FIG. 8A shows the S-shaped clips rotated horizontally allowing the user to affix the extra backpack or bag to itself via sliding horizontally rather than vertically.

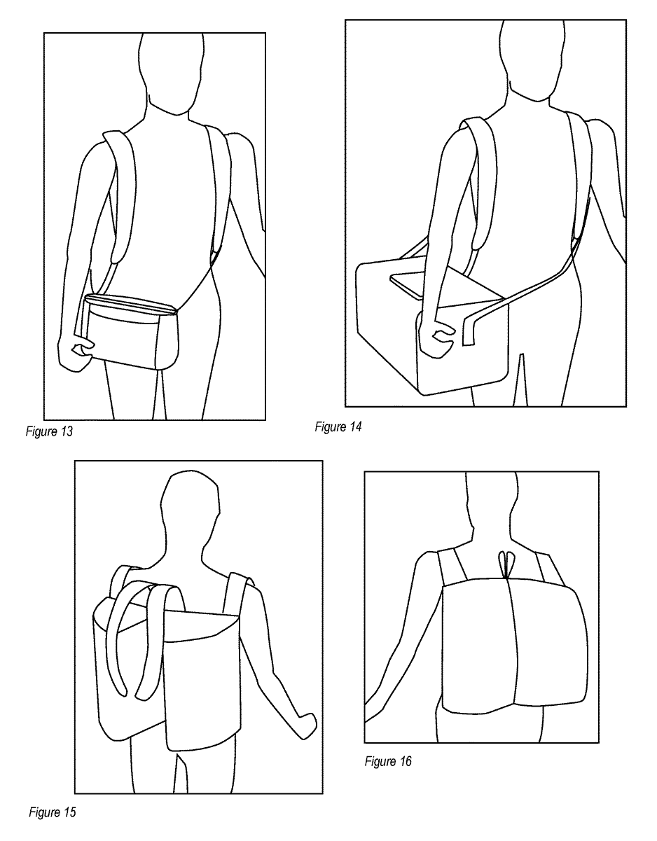

FIG. 12 shows one utility of the invention of carrying backpacks with a main bag. The small laptop bag is attached to the larger backpack via the s-shaped clip. The S clip can allow the user to attach multiple items to the main bag or carrier. Here it is a small travel backpack that can be worn in front or on back. Since the S clips are removable, they can be placed anywhere on the bag where there are webbing touch points sewn and any items can be attached via the clips. FIG. 13 shows that a purse can be attached to the backpack straps—one on the sternum and one on the side hip. FIG. 14 shows a duffel bag being able to be attached to the strap system. FIG. 15-16 shows that the S clip or other attaching hardware can be used on the sides of two bags and they can be attached and worn as a backpack, bypassing the two inside straps. This would alleviate the bags from slipping down the shoulder when you have to carry two bags such as a laptop bag and a gym bag.

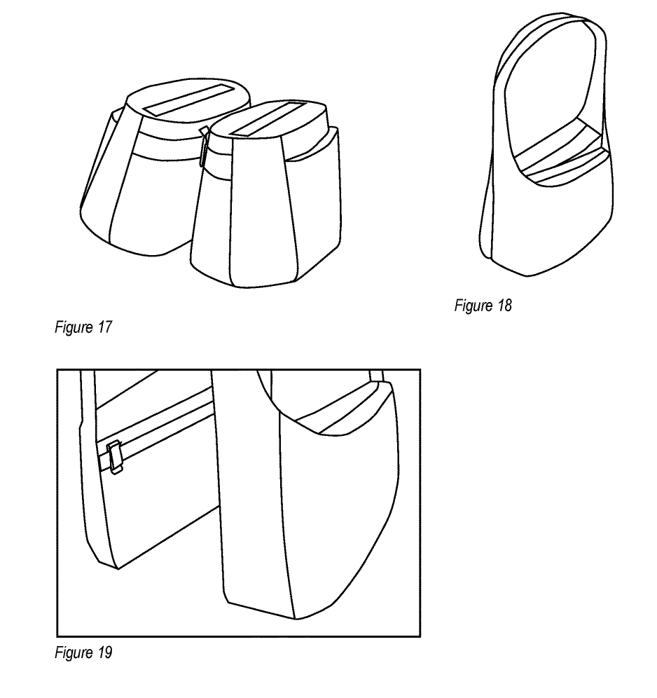

FIGS. 17-19 shows that even a small purse or shoulder bag can be outfitted with hardware so that another bag can be attached to it for travel or other needs. One bag could be a diaper bag left at daycare and the other could be for personal belongings.

FIG. 18-19 shows the diaper bag sets and its different embodiments. In this set, the two sides of the diaper bag are detachable. One of the sides is a diaper bag for baby and the other side is a purse which contains items for mother. This allows mother to carry her personal items and baby items and yet is able to travel without the baby items if needed. For example, if she drops off the baby at daycare, the baby items can be detached and she can take her personal items with her. The two bags attach via two S clips. The straps come together via a magnetic attachment and also could be secondarily attached with a velcro and tab.

While specific embodiments of the present invention have been provided, it is to be understood that these embodiments are for illustration purposes and not limiting. Many additional embodiments will be apparent to persons of ordinary skill in the art reading this disclosure.

What is claimed for is:

1. An apparatus which is a carrying item A and has the capability of attaching to another item B by means of an attachment point thus utilizing B's structure for load bearing and allowing A to be carried without its strap.

2. The apparatus in claim 1 comprising of:
a webbing;
an S-shaped attachment

3. The apparatus in claim 1 comprising of:
a webbing;
an S-shaped attachment clip with 4 hooks on it, 2 on each side of the S clip wherein the hooks are bent so as to catch the webbing under it and prevent it from sliding up or down along the S clip.

4. The middle portion of the S-shaped clip in claim 2 is hooked onto the webbing and on the right side the clip has webbing hooked onto it where the said clip can hold onto perpendicular pieces of webbing and also the said clip can be attached using the slit on the back.

5. The S-shaped clip in claim 2 may be provided with an additional secure attachment point attached perpendicular to S-shaped clip and this extra attachment is used to attach another item with webbing strips slid into this clip.

6. The S-shaped clip in claim 2 may have a back feature that allows the webbing to be slipped into it in order to provide more security and stability.

7. The S shaped clip in claim 2 may also be used to connect a diaper bag, inter alia, with a purse which is detachable and can be carried independently.
